(19) United States
(12) Patent Application Publication
(10) Pub. No.: US 2026/0042640 A1
(43) Pub. Date: Feb. 12, 2026

(54) OPERATING AN ELEVATOR DOOR

(71) Applicant: KONE Corporation, Helsinki (FI)

(72) Inventors: Matti Lin, Helsinki (FI); Petri Kuisma, Helsinki (FI)

(73) Assignee: KONE Corporation, Helsinki (FI)

(21) Appl. No.: 19/360,292

(22) Filed: Oct. 16, 2025

Related U.S. Application Data
(63) Continuation of application No. PCT/FI2023/050305, filed on May 31, 2023.

(51) Int. Cl. B66B 13/16

(52) U.S. Cl. CPC B66B 13/165

(57) ABSTRACT

A system operates an elevator door upon an elevator car residing at a landing zone of a landing and includes a locking mechanism having a rotatable lock hook assembly and a lock latch. The lock hook assembly includes a lock hook portion arranged to selectively engage or disengage the lock latch via rotation of the lock hook assembly to set the locking mechanism, respectively, into a locked state or an unlocked state, and an actuation assembly for rotating the lock hook assembly. A safety circuit indicates a state of the locking mechanism and includes a switch that is closed in the locked state of the locking mechanism and that is open in the unlocked state of the locking mechanism. A door controller is arranged to operate a door driving system, in dependence of movement of the elevator door.

### TECHNICAL FIELD

The example and non-limiting embodiments of the present invention relate to operation of an elevator door.

### BACKGROUND

Correct operation of elevator doors is an important aspect in terms of safety and convenience of elevator passengers. In particular, timely opening the doors to enable passengers to enter and exit an elevator car plays an important role in avoiding undue delays in passenger transport, while ensuring that doors can be opened only when the elevator car is in a position that enables safe movement between the elevator and a landing of the elevator system and ensuring that the doors remain closed when the elevator car is in transit between landings is an important aspect of passenger safety.

In many elevator systems the elevator doors are automatically operated such that opening and closing the elevator doors is carried out via usage of a driving system arranged in the elevator car, which driving system comprises an electric motor arranged to drive movement of the elevator doors under control of an elevator door controller. An elevator door is typically further provided with a locking mechanism that ensures keeping the elevator door closed when the elevator car is in transit between landings and that allows for opening the elevator door when the elevator car is positioned at a landing zone of a landing.

Correct and reliable operation of the locking mechanism is hence critical for safe operation of the elevator system. The locking mechanism is typically configured or calibrated upon manufacturing, installing or carrying out a maintenance operation to the elevator car such that it ensures keeping the elevator door closed when the elevator car is in transit between landings and allows for opening the elevator door when the elevator car is positioned at a landing zone. However, due to wear and tear of components associated with the elevator door as well as due to dust, dirt, etc. accumulating to the components associated with the elevator door, prolonged operation of the elevator car may result in compromised operation or even a malfunction of the locking mechanism, which may result in compromised elevator door operation. Since malfunction of the locking mechanism such that it fails to ensure keeping the elevator door closed during transit and/or such that it fails to allow for opening the elevator door when the elevator car stops at a landing may seriously compromise passenger safety, early detection of possibly compromised operation of the locking system would be advantageous.

### SUMMARY

It is an object of the present invention to provide a technique that facilitates detection of compromised operation of a locking mechanism of an elevator door.

According to an example embodiment of the present invention, a system for operating an elevator door upon an elevator car residing at a landing zone of a landing is provided, the system comprising: a locking mechanism comprising a rotatable lock hook assembly and a lock latch, wherein the lock hook assembly comprises a lock hook portion arranged to selectively engage or disengage the lock latch via rotation of the lock hook assembly to set the locking mechanism, respectively, into a locked state or an unlocked state, and an actuation assembly for rotating the lock hook assembly; a safety circuit for indicating a state of the locking mechanism, wherein the safety circuit comprises a switch that is closed in the locked state of the locking mechanism and that is open in the unlocked state of the locking mechanism; and a door controller arranged to operate a door driving system, in dependence of movement of the elevator door, to selectively relax the actuation assembly or to exert a force that causes the actuation assembly to rotate the lock hook assembly to set the locking mechanism into the locked or unlocked state, monitor an electric current in the safety circuit, and detect compromised operation of the locking mechanism in response to detecting said electric current upon relaxation of the actuation assembly when the elevator door is closed.

According to another example embodiment of the present invention, an elevator car for vertical movement within an elevator shaft of an elevator system between a first landing and at least one further landing is provided, the elevator car comprising a car door that is moveable between an open position and a closed position; a door driving system for driving movement of the car door between the open and closed positions; a door controller for controlling operation of the door driving system; and a locking mechanism for selectively locking or unlocking the car door, the locking mechanism comprising a rotatable lock hook assembly and a lock latch, wherein the lock hook assembly comprises a lock hook portion arranged to selectively engage or disengage the lock latch via rotation of the lock hook assembly to set the locking mechanism, respectively, into a locked state or an unlocked state, and an actuation assembly for rotating the lock hook assembly; and a safety circuit for indicating a state of the locking mechanism, wherein the safety circuit comprises a switch that is closed in the locked state of the locking mechanism and that is open in the unlocked state of the locking mechanism, wherein the door controller is further arranged to operate a door driving system, in dependence of movement of the elevator door, to selectively relax the actuation assembly or to exert a force that causes the actuation assembly to rotate the lock hook assembly to set the locking mechanism into the locked or unlocked state, monitor an electric current in the safety circuit, and detect compromised operation of the locking mechanism in response to detecting said electric current upon relaxation of the actuation assembly when the elevator door is closed.

The exemplifying embodiments of the invention presented in this patent application are not to be interpreted to pose limitations to the applicability of the appended claims. The verb “to comprise” and its derivatives are used in this patent application as an open limitation that does not exclude the existence of also unrecited features. The features described hereinafter are mutually freely combinable unless explicitly stated otherwise.

Some features of the invention are set forth in the appended claims. Aspects of the invention, however, both as to its construction and its method of operation, together with additional objects and advantages thereof, will be best understood from the following description of some example embodiments when read in connection with the accompanying drawings.

### BRIEF DESCRIPTION OF FIGURES

The embodiments of the invention are illustrated by way of example, and not by way of limitation, in the figures of the accompanying drawings, where

FIG. 1A schematically illustrates some aspects of an elevator system according to an example;

FIG. 1B illustrates a block diagram of some logical elements of an elevator control system according to an example;

FIG. 2 schematically illustrates some elements of a locking mechanism according to an example;

FIG. 3 schematically illustrates a safety circuit according to an example;

FIGS. 4A and 4B schematically illustrate some elements of a safety circuit in context of a locking mechanism according to an example; and

FIG. 5 illustrates a block diagram of some elements of an apparatus according to an example.

### DESCRIPTION OF SOME EMBODIMENTS

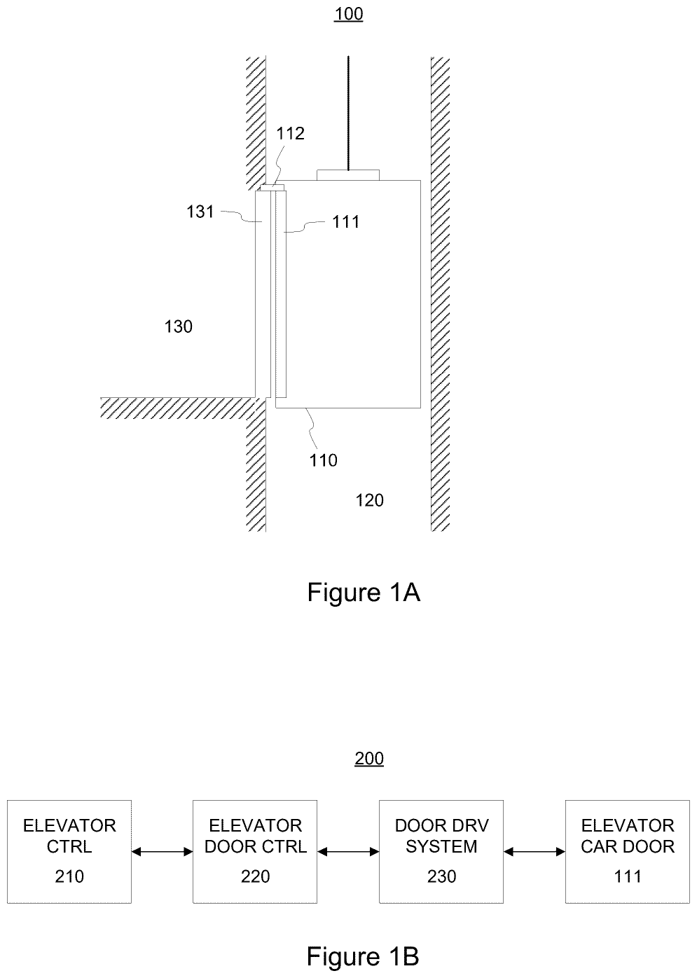

FIG. 1A schematically illustrates some aspects of an elevator system 100 provided with automatic doors according to an example, including an elevator car 110 that may be moved in the vertical direction within an elevator shaft 120 to enable transporting passengers and/or cargo between landings of the elevators system 100. The elevator system 100 may comprise at least two landings, while a landing 130 shown in the schematic illustration of FIG. 1A serves to represent any landing of the elevator system 100. The elevator car 110 is provided with a car door 111, wherein the car door 111 may comprise a sliding door that may is moveable between a closed position and an open position. The landing 130 is provided with a landing door 131, which is likewise moveable between the closed position and the open position. In normal operation of the elevator system 100 the landing door 131 may be opened and closed in concert with the car door 111 such that it may be opened only when the elevator car 110 is positioned within a landing zone of the landing 130 and it remains closed when the elevator car 110 is not at the landing zone of the landing 130. The aspect moving the car door 110 and the landing door 131 between the closed and open positions is described in further detail in the following.

FIG. 1B illustrates a block diagram of some logical elements of an elevator control system 200 according to an example. The elevator control system 200 may serve to control various aspects related to movement and operation of the elevator car 110. In this example, the elevator control system 200 is shown with an elevator controller 210 for controlling at least some aspects of movement of the elevator car 110 in the elevator shaft 120, a door driving system 230 for driving movement of the car door 111 of the elevator car 110 between the closed and open positions; and a door controller 220 for operating the door driving system 230 and for monitoring at least one aspect of operation of the car door 111 and/or the landing door 131.

Along the lines described in the foregoing, the elevator controller 210 may be arranged to control at least some aspects of movement of the elevator car 110 in the elevator shaft 120. The elevator controller 210 is typically installed outside the elevator car 110, for example in a suitable location in the elevator shaft 120 or in its close proximity, and it may comprise or it may be provided using one or more computer apparatuses that each comprise respective one or more processors and one or more respective memories storing one or more computer programs, where the one or more processors are arranged to execute the one or more computer programs to cause the one or more computer apparatuses to operate as the elevator controller 210. Hence, the elevator controller 210 may be provided as an elevator control apparatus (e.g. via using a single computer apparatus) or as an elevator control system (e.g. via using two or more computer apparatuses).

The elevator controller 210 is communicatively coupled to the door controller 220, where the communicative coupling between the elevator controller 210 and the door controller 220 may be provided using a wired communication network or communication link, using a wireless communication network or communication link, or using a combination of a wireless communication network or communication link and a wireless communication network or communication link. The elevator controller 210 may be further communicatively coupled to one or more further elevator controllers that may be arranged for controlling at least some aspect of movement of respective elevator cars in other elevator shafts and/or to an elevator group controller arranged to control at least some aspects related to movement of a plurality of elevator cars in a plurality of elevator shafts.

Operation of the elevator controller 210 in terms of controlling movement of the elevator car 110 may involve, for example, controlling the speed of the elevator car 110 via control of one or more electric motors arranged for driving the elevator car 110 and controlling a braking system arranged for keeping the elevator car 110 in its position when stopped at a landing. In context of the present disclosure, however, aspects of specific interest pertain to operation of the door controller 220 in terms of monitoring at least one aspect of operation of the car door 111 and/or the landing door 131 and, consequently, any further details pertaining to the operation of the elevator controller 210 and/or movement of the elevator car 110 along the elevator shaft 120 are described herein only to extent they are necessary for describing examples that pertain to said monitoring carried out via operation of the door controller 220. In this regard, aspects related to general operation of the elevator controller 210 in controlling movement of the elevator car 110 along the elevator shaft 120 may be provided using techniques known in the art.

Along the lines described in the foregoing, the door driving system 230 may be arranged to drive movement of the car door 111 between the closed position and the open position. In this regard, the door driving system 230 may operate under control of the door controller 220, e.g. in accordance with one or more door control signals received from the door controller 220. The door driving system 230 may comprise an electric motor and a motor controller arranged to control operation of the electric motor that is coupled to the car door 111 via a transmission system such that operation of the electric motor causes linear movement of the elevator car door 111 in a direction that is substantially parallel with an opening in a wall of the elevator shaft 120 at the landing 130, thereby enabling movement of the car door 111 between the closed and open positions. The transmission system may be arranged to convert the rotary motion provided by the electric motor into the linear movement of the car door 111. Characteristics of the transmission system may be selected in accordance with requirements of a specific implementation of the elevator car 110, the car door 111 and/or the door driving system 230, and the transmission system may involve, for example, one or more of the following: a belt drive, a chain drive, a gear train.

The door controller 220 is typically installed in the elevator car 110, for example in suitable location in the interior of the elevator car 110 (e.g. in a ceiling structure of the elevator car 110) or on the exterior of the elevator car 110 (e.g. on the roof of the elevator car 110). The door controller 220 may comprise or may be provided using a computer apparatus comprising one or more processors and one or more memories storing one or more computer programs, where the one or more processors are arranged to execute the one or more computer programs to cause the computer apparatus to operate as the door controller 220. Hence, the door controller 220 may be provided as a door controller apparatus. Along the lines described in the foregoing, the door controller 220 is communicatively coupled to the elevator controller 210, whereas the door controller 220 is further communicatively coupled to the door driving system 230, where the communicative coupling between the door controller 220 and the door driving system 230 may be provided using a wired or wireless communication network and/or communication link.

The aspect of the door controller 220 controlling the movement of the car door 111 between the closed and open positions may comprise at least the following operations with respect to moving the elevator car door 111:
move the car door 111 in a first direction to open the car door 111,
move the car door 111 in a second direction that is opposite of the first direction to close the car door 111.

Each of these operations may be effected via the door controller 220 issuing a respective control signal to the door driving system 230. The door controller 220 may further enable, for example, setting and/or adjusting movement speed of the car door 111 via application of a respective control signal.

The elevator car 110 may further comprise a door coupler 112 attached to the car door 111 for temporarily coupling the landing door 131 of the landing 130 to the car door 111 when the elevator car 110 resides within the landing zone of the landing 130. In this regard, the door coupler 112 may be arranged to temporarily couple the landing door 131 to the car door 111 upon the elevator car 110 stopping to a position within the landing zone of the landing 130 and to decouple the landing door 131 from the car door 111 before the elevator car 110 leaving the landing zone. As examples in this regard, the coupling may be provided via operation of the door driving system 230 (e.g. under control of the door controller 220) and/or via operation of an actuation member included in or coupled to the door coupler 112. whereas the decoupling may be provided via operation of the door driving system 230. Hence, when the car door 111 is moved between the closed and open positions (via operation of the door driving system 230), the landing door 131 moves along with the car door 111. Opening and closing the landing door 131 together with the car door 111 facilitates passenger safety via opening the landing door 131 only when the elevator car 110 is positioned at the landing 130 and closing the landing door 131 before the elevator car 110 leaves the landing 130.

The door coupler 112 may comprise one or more coupling elements for engaging with one or more counter elements attached to the landing door 131 when the elevator car 110 resides within the landing zone of the landing 130. Hence, the landing door 131 may be coupled to the car door 111 via the one or more coupling elements engaging the one or more counter elements and the landing door 131 may be decoupled from the car door 111 via the one or more coupling elements disengaging from the one or more counter elements. In this regard, operation of the door coupler 112 in response to the elevator car 110 stopping at a position within a landing zone of the landing 130 may be outlined in the following manner:
The one or more coupling elements may be arranged to engage with the one or more counter elements upon the elevator car 110 stopping at a position within the landing zone of the landing 130, thereby coupling the landing door 131 to the car door 111 in order to prepare for opening the doors 111, 131 for passenger movement between the elevator car 111 and the landing 130.
The one or more coupling elements may be arranged to remain engaged with the one or more counter elements when moving the car door 111 between the closed and open positions, thereby moving the landing door 131 together with the car door 111 when the latter is moved between the open and closed positions.
The one or more coupling elements may be arranged to disengage from the one or more counter elements when moving the car door 111 back to its closed position, thereby decoupling the landing door 131 from the car door 111 in order to prepare for the elevator car 110 departing from the landing 130.

The above-described door opening and closing cycle may be followed by the elevator car 110 departing from the landing 130 to serve a subsequent transport call or the elevator car 110 standing by at the landing 130 in case there are no further transport calls to be served. In the latter scenario, the one or more coupling elements may be arranged to re-engage the one or more counter elements, thereby re-coupling the landing door 131 to the car door 110.

The one or more coupling elements of the door coupler 112 and the one or more counter elements of the landing door 131 are positioned with respect to each other such that, when the elevator car 110 is stopped at a position within the landing zone of the landing 130, the one or more coupling elements are brought into relatively close proximity of the one or more counter elements to enable the one or more coupling elements to engage the one or more counter elements via a first predefined movement and to disengage from the one or more counter elements via a second predefined movement (that may be substantially the first movement in reverse). In an example, the one or more coupling elements may be attached to a portion of the elevator car 110 above the car door 111 or to a top portion of the car door 111 while the one or more counter elements may be attached to a top rack provided above the landing door 131 or to a top portion of the landing door 131. The first movement of the one or more coupling elements to engage the one or more counter elements may be triggered by the elevator car 110 stopping at a position within the landing zone, whereas the second movement of the one or more coupling elements to disengage from the one or more counter elements may be triggered by the car door 111 closing.

The first movement may involve a predefined lateral movement (e.g. in a direction of the plane of car door 111) of at least one of the one or more coupling elements in a first direction, whereas the second movement may involve a predefined lateral movement of said at least one of the one or more coupling elements in a second direction that is opposite the first direction. The movement of the one or more coupling elements may be provided via using the door driving system 230 (e.g. under control of the door controller 220) to exert a force that results in movement of the one or more coupling elements of the door coupler 112. In this regard, the first movement of the one or more coupling elements upon the elevator car 110 stopping at a position within the landing zone may be provided e.g. via operating the door driving system 230 to exert a first force to the one or more coupling elements when starting to move the car door 111 from its closed position towards the open position, whereas the second movement of the one or more coupling elements upon closing the car door 111 may be provided e.g. via operating the door driving system 230 to exert a second force to the one or more coupling elements when having closed the car door 111. The first force may be the force exerted via the door coupler 112 to the car door 111 and to the landing door 131 temporarily coupled thereto for moving the elevator doors 111, 131 towards the open position, whereas the second force may be the force exerted via the door coupler 112 to the car door 111 and to the landing door 131 temporarily coupled thereto for moving the elevator doors 111, 131 towards the closed position. When the first or second force is exerted to the door coupler 112, it may be considered to be in an active state.

In case there are further transport calls to be served, the door driving system 230 may be operated to continue exerting the second force to the one or more coupling elements to keep the landing door 131 decoupled from the car door 111 to ensure undisturbed departure of the elevator car from the landing 130, whereas in case there are no further transport calls to be served, the door coupler 112 may enter a relaxed state where the door driving system 230 does not exert a force to the one or more coupling elements. When entering the relaxed state, the actuation member included in or coupled to the door coupler 112 may be arranged to cause the first movement of the one or more coupling elements to engage the one or more counter elements. In this regard, the actuation member may exert a third force to the one or more coupling elements to cause the first movement thereof. The third force is sufficient to cause the first movement of the one or more coupling elements upon entering the relaxed state, while the third force may be substantially smaller than the first and second forces applied for moving the car door 111 and the landing door 131 temporarily coupled thereto. The second force also needs be larger than the third force to allow for the second movement of the one or more coupling elements when the door driving system 230 is applied for actuating such movement of the coupling elements despite the third force exerted by the actuation member. The actuation member may comprise, for example, a spring that is arranged to push or pull the one or more coupling elements to a direction that results in the first movement of the one or more coupling elements, thereby keeping the landing door 131 coupled to the car door 111 during the relaxed state of the door coupler 112.

According to an example, the one or more coupling elements of the door coupler 112 may comprise a pair of coupling vanes arranged to the elevator car 110 above the car door 111 (or to a top portion of the car door 111) such that they extend in movement direction of the elevator car 110 (i.e. in a vertical direction) and project towards the landing door 131, thereby forming a vertical ‘slot’ that has its open side directed towards the landing door 131, whereas the one or more counter elements may comprise two or more rollers mounted on the top rack provided above the landing door 131 (or in a top portion of the landing door 131) and projecting towards the elevator shaft 120, the respective axes of the one or more rollers being substantially perpendicular to the plane of the landing door 131. In this regard, the two or more rollers may be positioned such that when the elevator car 110 is positioned within the landing zone of the landing 130, the two or more rollers are located within the ‘slot’ formed by the pair of coupling vanes.

In particular, the first movement triggered upon the elevator car stopping at a position within the landing zone of the landing 130 may involve the coupling vanes moving closer to each other to engage the two or more rollers and hence temporarily couple the landing door 131 to the car door 111. Consequently, the landing door 131 may become readily coupled to the car door 111 and it may move with the car door 111 upon moving the latter via operation of the door driving system 230. Conversely, the second movement triggered upon moving the car door 111 back to its closed position may involve the coupling vanes moving away from each other to disengage from the two or more rollers, thereby decoupling the landing door 131 from the car door 111.

In another example the positioning of the one or more pair of coupling vanes 112a in relation to the two or more rollers may be such that, when the elevator car 110 is moving along the elevator shaft 120 past the landing door 131, the pair of coupling vanes are passed between the two or more rollers. Hence, the first movement may involve the coupling vanes moving away from each other to engage the two or more counter elements, thereby temporarily coupling the landing door 131 to the car door 111. Conversely, the second movement may involve the coupling vanes moving closer to each other to disengage from the two or more rollers, thereby decoupling the landing door 131 from the car door 111.

In order to ensure that car door 111 and the landing door 131 are opened only when the elevator car 110 is stopped to a position within the landing zone of the landing 130, each of the car door 111 and the landing door 130 may be provided with a respective locking mechanism that enables locking or unlocking the respective one of the doors 111, 131. The locking mechanism for the car door 111 may be applied to keep the car door 111 locked when the elevator car 110 is moving along the elevator shaft 120 between landings of the elevator system 100 and to unlock the car door 111 when elevator car 110 is positioned within a respective landing zone of any of the landings of the elevator system 100. The locking mechanism for the landing door 131 may be applied to keep the landing door 131 locked when the elevator car 110 is not positioned at the landing zone and to unlock the landing door 131 when the elevator car 110 is positioned within the landing zone of the landing 130.

In various examples in this regard, the locking mechanism for the car door 111 may be applied to unlock the car door 111 upon the elevator car 110 entering a landing zone of a landing of the elevator system 100, upon the elevator car 110 stopping at a position within the landing zone of the respective landing, or in the course of a procedure for opening the car door 111 via operation of the door driving system 230, whereas locking the car door 111 may be carried out e.g. in the course of a procedure for closing the car door 111, upon the elevator car 110 leaving the respective landing, or upon the elevator car 110 exiting the landing zone of the respective landing. Along similar lines, the locking mechanism for the landing door 131 may be applied to unlock the landing door 131 upon the elevator car 110 entering the landing zone of the landing 130, upon the elevator car 110 stopping at a position within the landing zone of the landing 130, or in the course of a procedure for opening (the car door 111 and) the landing door 131 via operation of the door driving system 230, whereas locking the landing door 131 may be carried out e.g. in the course of a procedure for closing (the car door 111 and) the landing door 131, upon the elevator car 110 leaving the landing 130, or upon the elevator car 110 exiting the landing zone of the landing 130.

In the following examples, where applicable, the term elevator door 111, 131 is applied to refer to one or both of the car door 111 and the landing door 131 as an editorial choice made in the interest of ensuring clarity and brevity of description via avoidance of extensive repetition of the terms car door 111 and landing door 131 throughout the examples.

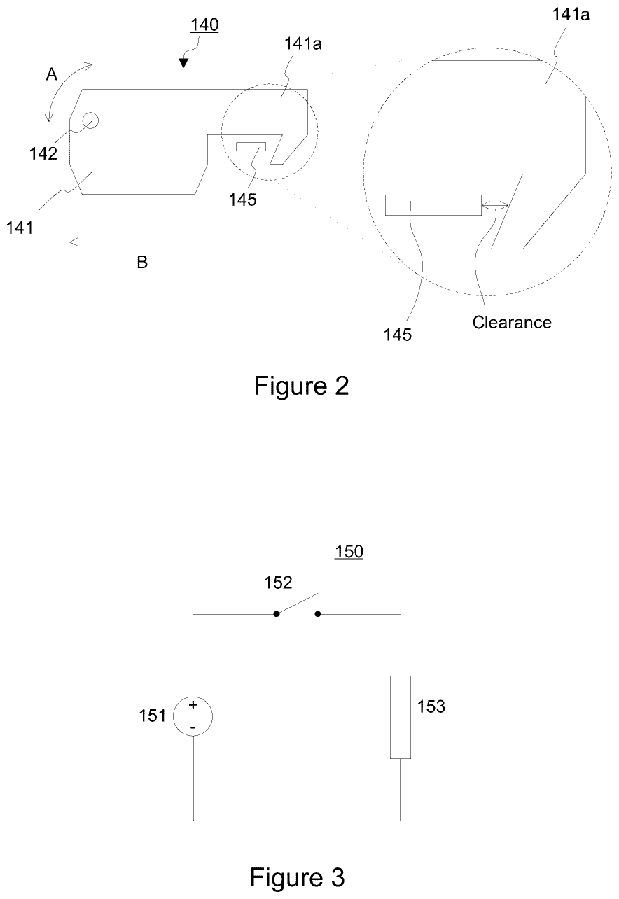

FIG. 2 schematically illustrates a locking mechanism 140 according to an example, where the locking mechanism 140 comprises a lock hook assembly 141 for arrangement in the elevator door 111, 131 and a lock latch 145 for arrangement in a structure that is adjacent to the elevator door 111, 131, e.g. to a frame of the elevator door 111, 131. The lock latch 145 may be also referred to as a lock counterpart. The lock hook assembly 141 may be rotatable about an axis 142 (as indicated by the curved arrow A) and it may comprise a lock hook portion 141a for engaging the lock latch 145. The lock hook assembly 141 and the lock latch 145 may be installed with respect to each other such that when the elevator door 111, 131 is in the closed position, the lock hook portion 141a may be brought via a rotating movement of the lock hook assembly 141 in a first direction (e.g. in the clockwise direction as in the illustration of FIG. 2) into a position where it engages the lock latch 145, whereas the lock latch 145 may be disengaged from the lock hook portion 141a via a rotating movement of the lock hook assembly 141 in a second direction that is the opposite of the first direction (e.g. the counter-clockwise direction as in the illustration of FIG. 2). The position of the lock hook assembly 141 where it engages the lock latch 145 may be referred to as a locked (or closed) state of the locking mechanism 140, whereas the position of the lock hook assembly 141 where it does not engage the lock latch 145 may be referred to as an unlocked (or open) state of the locking mechanism 140.

The locking mechanism 140 may further comprise a lock hook actuation assembly (not shown in the illustration of FIG. 2) for rotating the lock hook assembly 141 by a predefined amount in the first direction such that the lock hook portion 141 engages the lock latch 145 when the elevator door 111, 131 is to be locked and for rotating the lock hook assembly 141 by the predefined amount in the second direction such that the lock latch 145 is disengaged from the lock hook portion 141a when the elevator door 111, 131 is to be unlocked. The lock hook actuation assembly may be provided using a suitable mechanical or electromechanical arrangement known in the art. As an example in this regard, the door coupler 112 may further serve as the lock hook actuation assembly such that operation of the door coupler 112 to couple the landing door 131 to the car door 111 is arranged also to rotate the lock hook assembly 141 in the second direction (to cause disengaging the lock latch 145 from the lock hook portion 141a) in order to unlock the elevator door 111, 131 and such that operation of the door coupler 112 to decouple the landing door 131 from the car door 111 is arranged also to rotate the lock hook assembly 141 in the first direction (to cause the lock hook portion 141a engaging the lock latch 145) in order to lock the elevator door 111, 131.

As pointed out above, the illustration of FIG. 2 is a schematic one that serves to illustrate the operating principle of the exemplifying locking mechanism 140 applicable for locking and unlocking the elevator door 111, 131 where the lock hook portion 141a of the lock hook assembly 141 may be caused to engage or disengage the lock latch 145 via the rotating movement of lock hook assembly 141. In this regard, the respective shapes and sizes of the lock hook assembly 141 and the lock latch 145, their arrangement with respect to each other as well as their orientation and/or position with respect to the elevator door 111, 131 may differ from that described with references to the illustration of FIG. 2 without departing from the scope of the present disclosure as far as their positions with respect to each other enable selectively locking or unlocking the elevator door 111, 131 via rotary motion of the lock hook assembly 141.

While the locking mechanism according to the example described above involves a relatively simple mechanical structure that serves as a proven solution for locking the elevator door 111, 131, it needs to be carefully calibrated in terms of lock clearance, i.e. in terms of the clearance between the lock hook portion 141a and the lock latch 145 (as illustrated in FIG. 2), to ensure reliable operation. In this regard, a sufficient lock clearance ensures undisturbed movement of the lock hook portion 141a with respect to the lock latch 145 without a contact between the two when rotating the lock hook assembly 141 while still ensuring locking that substantially prevents opening the elevator door 111, 131 without rotating the lock hook assembly 141. In contrast, less than sufficient lock clearance results in a contact between the lock hook portion 141a and the lock latch 145 upon rotating the lock hook assembly 141, which risks the lock hook portion 141a getting stuck with the lock latch 145 and, consequently, preventing unlocking—and hence opening—of the elevator door 111, 131. This, in turn, runs a risk of preventing passengers from entering or exiting the elevator car 110 upon its arrival at the landing 130, where especially the latter may be considered to constitute a serious risk for convenience and safety of passengers.

The lock clearance may be calibrated to a reference value, for example, upon installing components of the elevator system 100 that have a direct or indirect effect on movement of the elevator door 111, 131 or upon carrying out a maintenance operation that may have an effect on respective positions of the car door 111 and the landing door 131 with respect to each other and/or with respect to the elevator car 110, thereby ensuring sufficient lock clearance and, consequently, ensuring reliable opening and closing of the elevator door 111, 131 at the landing 130. However, over time, the wear and tear of components of the elevator car 110, the car door 111 and/or the landing door 131 as well as sand, dust, dirt, etc. accumulating to the components of the elevator car 110, the car door 111, the landing door 131 and/or to the landing 130 may result in a situation where the lock clearance has become smaller than the reference value set upon calibration. Such a scenario, in turn, may result in jamming the locking mechanism due to contact between the lock hook portion 141a and the lock latch 145 upon rotary motion of the lock hook assembly 141.

The locking mechanism may be further provided with a safety circuit 150 illustrated in FIG. 3, where the safety circuit 150 comprises a switch 152 and a load 153 arranged in series between nodes of a voltage source 151. The switch 152 is closed when the locking mechanism 140 is in the locked state and that is open when the locking mechanism 140 is in the unlocked state. Hence, the switch 152 is closed upon setting the locking mechanism 140 into the locked state when the elevator door 111, 131 is closed and that the switch 152 is opened upon setting the locking mechanism 140 into the unlocked state when the elevator door 111, 131 is to be opened. Consequently, electric current flows in the safety circuit 150 when the locking mechanism 140 is in the locked state and the electric current does not flow in the safety circuit 150 when the locking mechanism 140 is in the unlocked state. This enables observing the state of the locking mechanism via monitoring the current through the safety circuit 150.

The load 153 of the safety circuit 150 may comprise one or more electrical components. According to an example, the load 153 may comprise e.g. a light emitting diode (LED) and/or an arrangement of components that enables measuring the electric current in the safety circuit 150. In this regard, though, the concept of safety circuit 150 is to be construed broadly, encompassing any electric circuit or a branch of an electric circuit where a flow of electric current may be enabled or disabled via operation of the switch 152 and where the electric current through the switch 152 may be monitored via operation of the door controller 220.

The switch 152 of the safety circuit 150 may be provided, for example, by a first switch element 152a attached to the lock hook assembly 141 and a second switch element 152b disposed in a position where it comes into contact with the first switch element 152a when the lock hook portion 141a of the lock hook assembly 141 engages the counter element 145 in the locked state of the locking mechanism 140 and, conversely, there is no contact between the first switch element 152a and the second switch element 152b when the lock hook portion 141a of the lock hook assembly 141 does not engage the lock latch 145 in the unlocked state of the locking mechanism 140. As an example, one of the first and second switch elements 151a, 152b may comprise one or more plugs and the other one of the first and second switch elements 151a, 152b may comprise one or more sockets for receiving the respective ones of the one or more plugs to close the switch 152. Consequently, the switch 152 may be closed by inserting the one or more plugs into the respective one or more sockets into at least a predefined depth and, conversely, the switch 152 may be opened by retracting the one or more plugs from the respective one or more sockets either completely or such that they do not reach the predefined depth. In specific examples, one, two or three plugs and the corresponding number of sockets may be applied.

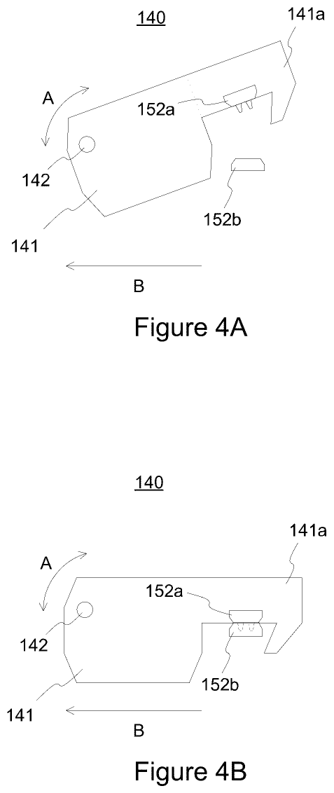

FIGS. 4A and 4B schematically illustrate the aspect of providing the switch 152 via the first and second switch elements 152a, 152b. In this regard, FIG. 4A shows the lock hook assembly 141 in the unlocked position of the locking mechanism 140 with the first switch element 152a mounted to the lock hook portion 141a such that when the lock hook assembly 141 is rotated into the locked position of the locking mechanism 140, the first switch element 152a is brought into contact with the second switch element 152b. FIG. 4B shows the lock hook assembly 141 in the locked position of the locking mechanism 140, where the first switch element 152a is brought into contact with the second switch element 152b. In respective illustrations of FIGS. 4A and 4B the lock latch 145 (shown In FIG. 2) is omitted to ensure graphical clarity. In non-limiting examples, the second switch element 152 may be attached to the lock latch 145 or to a structure that is adjacent to the elevator door 111, 131, e.g. to a frame of the elevator door 111, 131.

As described in the foregoing, according to an example, the door coupler 112 may further serve as the actuation assembly for rotating the lock hook assembly 141 of the locking mechanism 140. This is an advantageous since unlocking the elevator door 111, 131 is required substantially simultaneously with coupling the landing door 131 to the car door 111 via operation of the door coupler 112 to enable opening the elevator door 111, 131, whereas locking the elevator door 111, 131 is required substantially simultaneously with decoupling the landing door 131 from the car door 111 via operation of the door coupler 112 to prepare for the elevator car 110 departing from the landing 130. In other examples, though, an actuation assembly separate from the door coupler 112 may be applied instead.

Referring to the example that employs the door coupler 112 as the actuation mechanism for the locking mechanism 140, at least one of the one or more counter elements may be coupled to the lock hook assembly 141
such that the lock hook assembly 141 is caused to rotate to the second direction to disengage the lock latch 145 from the lock hook portion 141a in response to the first movement of the one or more coupling elements to engage the one or more counter elements, and
such that the lock hook assembly 141 is caused to rotate to the first direction to the lock latch 145 in response to the second movement of the one or more coupling elements to disengage the one or more counter elements.

In the example where the one or more coupling elements of the door coupler 112 comprise the pair of coupling vanes and the one or more counter elements comprise the two or more rollers, at least one of the two or more rollers may be coupled to the lock hook assembly 141 in a manner that results in the above-described movement of the lock hook assembly 141 in response to coupling vanes engaging or disengaging the two or more rollers.

As described in the foregoing, the door controller 220 may monitor the state of the locking mechanism 140 via monitoring the current through the safety circuit 150: when the electric current flows through the safety circuit 150 (e.g. through the switch 152), the locking mechanism 140 is in the locked state and the when the electric current does not flow through the safety circuit 150 (e.g. through the switch 152), the locking mechanism 140 is in the unlocked state. Moreover, when using the door coupler 112 as the actuation assembly for rotating the lock hook assembly 141, a status of the door coupler 112 provides an indirect indication of an assumed status of the locking mechanism:
when the door driving system 230 is applied to exert the first or second force to the door coupler 112 for moving the elevator doors 111, 131 between the closed and open positions, the locking mechanism 140 is assumed to be in the unlocked state,
when the door driving system 230 is applied to exert the second force to the door coupler 112 after having closed the elevator doors 111, 131 and decoupled the landing door 131 from the car door 111, the locking mechanism 140 is assumed to be in the locked state, and
when the door coupler 112 is in the relaxed state after having decoupled the landing door 131 from the car door 111 upon closing the elevator doors 111, 131, the locking mechanism 140 is assumed to be in the unlocked state.

In a situation where the lock clearance becomes gradually smaller in the course of usage of the elevator system 100 and over time it may reach a point where the rotary motion of the lock hook assembly 141 is disturbed due to contact between the lock hook portion 141a and the lock latch 145. In this regard, a minor contact between the lock hook portion 141a and the lock latch 145 may still allow for the rotary motion of the lock hook assembly 141 for setting the locking mechanism 140 into unlocked or locked state when sufficient force is exerted to the door coupler 112 serving as the actuation assembly, whereas further reduction of the lock clearance may result in a situation where the lock hook assembly 141 is not able to rotate in the second direction to an extent that results in disengaging lock latch 145 from the lock hook portion 141a due to the contact between the two, thereby ‘jamming’ the locking mechanism 140 in the locked state.

Since the first force applied to cause the door coupler 112 to temporarily couple the landing door 131 to the car door 111 and at the same time rotate the lock hook assembly 141 is larger than the third force exerted to the door coupler 112 in its relaxed state, the minor contact between the lock hook portion 141a and the lock latch 145 may not prevent the rotary motion of the lock hook assembly 141 upon exerting the first force to the door coupler 112, whereas the third force exerted to the door coupler 112 by the actuation member upon its relaxed state may not be sufficient to cause the rotary motion. Consequently, the locking mechanism 140 may remain in the locked state upon relaxation of the door coupler 112, which may serve as an indication of the lock clearance having diminished to a point where the rotary motion of the lock hook assembly 141 is disturbed at least to some extent.

The door controller 220 may be arranged to detect compromised operation of the elevator door 111, 131 in response to observing a situation where the electric current flows in the safety circuit 150, e.g. through the switch 152, while the door coupler 112 serving as the actuation assembly of the locking mechanism 140 is in the relaxed state after having closed the elevator door 111, 131. The door controller 220 may monitor the state of the door coupler 112 (e.g. the active state or the relaxed state) via observing at least one aspect of operation of the door driving system 230 in moving the elevator door 111, 131. In this regard, the door coupler 112 may be considered to be in the active state when the elevator door 111, 131 is not in the closed position and/or the door driving system 230 is applied to exert the first force or the second force to the door coupler 112 in order to move the elevator door 111, 131, whereas the door coupler 112 may be considered to be in the relaxed state when the elevator door 111, 131 is closed and neither the first force nor the second force is exerted thereto via operation of the door driving system 230. In order to carry out monitoring of the state of the door coupler 112, the door controller 220 may receive and/or derive one or more parameters that are descriptive of aspects of the movement and/or position of the elevator door 111, 131, e.g. one or more of the following:
position of the elevator door 111, 131, e.g. in terms of the door position with respect to the (fully) open position and/or with respect to the (fully) closed position,
movement speed of the elevator door 111, 131,
power consumption of the electric motor of the door driving system 230 serving to drive movement of elevator door 111, 131,
torque of the electric motor of the door driving system 230 serving to drive movement of the elevator door 111, 131.

The position of the elevator door 111, 131 may be derived, for example, via monitoring a position of a component of the transmission system of the door driving system 230, which position is at least indirectly indicative of the (relative) position of the elevator door 111, 131 with respect to its open and/or closed positions. As an example in this regard, in case the transmission system of the door driving system 230 comprises a belt drive assembly, the measure of interest may comprise a position of (a predefined reference point in) a driving belt of the belt drive assembly and/or the traveling distance of the driving belt with respect to the fully closed or fully open position of the elevator door 111, 131. The movement speed of the elevator door 111, 131 may be derived, for example, via observing a time series of (at least two) positions of the elevator door 111, 131 over a time window.

The power consumption of the electric motor of the door driving system 230 may be monitored, for example, via directly monitoring a measure of power consumption of the electric motor or via monitoring one or more parameters that are indirectly descriptive of the power consumption of the electric motor. Examples of the latter include electric current and/or voltage supplied to the electric motor of the door driving system 230, e.g. the magnitude and/or phase of the electric current and/or the voltage supplied to the electric motor. Respective indications of characteristics of the electric current and/or the voltage supplied to the electric motor may be obtained, for example, from the motor controller or from respective measurement arrangements applied for measuring the electric current and/or the voltage supplied to the electric motor. Along similar lines, an indication of the torque of the electric motor may be obtained, for example, from the motor controller or from a monitoring arrangement applied for measuring the torque of the electric motor.

The aspect of the door controller 220 monitoring of at least one aspect of movement of the elevator door 111, 131 may comprise the door controller 220 reading, receiving or deriving, upon using the door driving system 230 to open or close the elevator door 111, 131, respective values for the one or more parameters that are descriptive of movement of the elevator door 111, 131 according to a predefined schedule, e.g. at predefined time intervals. As an example in this regard, predefined time interval may be chosen from the range from 10 to 100 milliseconds, e.g. 50 milliseconds.

In case the door controller 220 detects compromised operation of the locking mechanism 140, the door controller 220 may proceed to taking one or more predefined actions. In this regard, the predefined action(s) may comprise issuing an alert or a maintenance call e.g. via transmitting a message in this regard to the elevator controller 210, which may forward the alert or maintenance call to a further entity in order request necessary maintenance to be carried out in order to restore proper operation of the locking mechanism. As an example, the alert or maintenance call may identify the elevator car 110 and/or the landing 130 for which the compromised operation of the locking mechanism 140 is identified, thereby enabling the elevator controller 220 to take further action in this regard. In another example, additionally or alternatively, in case the compromised operation of the locking mechanism 140 pertains to the car door 111, the predefined action(s) may involve the elevator controller 210 temporarily disabling operation of the elevator car 110.

In another example, the elevator controller 220 may take further action in response to receiving the alert or maintenance call from the door controller 210 of the elevator car 110. In one example, the elevator controller 220 may temporarily disable operation of the elevator car 110 in response to receiving alert or maintenance call suggesting compromised operation of the locking mechanism of the car door 111. In another example, in case the elevator controller 220 receives an alert or maintenance call that pertains to the compromised operation of the locking mechanism 140 of the landing door 131 of the landing 130 (and/or to a respective landing door of another landing of the elevator system 100), the elevator controller 220 may proceed to temporarily disable access to the elevator car 110 and from the elevator car 110 via the landing 130 (and/or via the other landing) in order to ensure safety of the passengers while allowing operation of the elevator car 110 and access to/from the elevator car 110 via other landings, thereby minimizing the downtime (and hence inconvenience to passengers) of the elevator car 110.

In the foregoing, the description refers to the elevator door 111, 131 in singular. However, the description readily generalizes into controlling and monitoring movement of at least one elevator door 111, 131, e.g. a double-door assembly arranged in the elevator car 110 and/or a double door assembly arranged in the landing 130. A double door assembly comprises a first door leaf and a second door leaf that are moveable such that the first and second door leaves are moved away from each other when opening and moved towards each other when closing, where the door driving system 230 may be applied for driving the movement of both door leaves. In such an arrangement, the lock hook assembly 141 may be arranged in the first door leaf and the lock latch 145 may be arranged in the second door leaf (instead of arranging one of the lock hook assembly 141 and the lock latch 145 to an adjacent structure such as the door frame).

In the foregoing, the description refers arranging the lock hook assembly 141 to the elevator door 111, 131 and arranging the lock latch 145 to an adjacent structure such as the door frame or to another elevator door, whereas in other non-limiting examples the arrangement of the lock hook assembly 141 and the lock latch 145 with respect to the elevator door 111, 131 and the door frame may be the opposite, such that the lock hook assembly 140 is arranged in the adjacent structure such as the door frame while the lock latch 145 is arranged in the elevator door 111, 131.

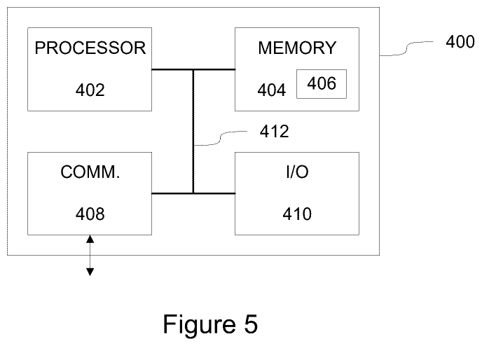

Along the lines described in the foregoing, the door controller 220 may comprise or may be provided using a computer apparatus comprising one or more processors and one or more memories storing one or more computer programs, where the one or more processors are arranged to execute one or more computer programs to operate as the door controller 220. As an example in this regard, FIG. 5 illustrates a block diagram of some components of an apparatus 400 that may be employed to implement the door controller 220.

The apparatus 400 comprises a processor 410 and a memory 420. The memory 420 may store data and computer program code 425. The apparatus 400 may further comprise communication means 430 for wired or wireless communication with other apparatuses and/or user I/O (input/output) components 440 that may be arranged, together with the processor 410 and a portion of the computer program code 425, to provide the user interface for receiving input from a user and/or providing output to the user. In particular, the user I/O components may include user input means, such as one or more keys or buttons, a keyboard, a touchscreen or a touchpad, etc. The user I/O components may include output means, such as a display or a touchscreen. The components of the apparatus 400 are communicatively coupled to each other via a bus 450 that enables transfer of data and control information between the components.

The memory 420 and a portion of the computer program code 425 stored therein may be further arranged, with the processor 410, to cause the apparatus 400 to perform at least some aspects of operation of the door controller 220 described in the foregoing. The processor 410 is configured to read from and write to the memory 420. Although the processor 410 is depicted as a respective single component, it may be implemented as respective one or more separate processing components. Similarly, although the memory 420 is depicted as a respective single component, it may be implemented as respective one or more separate components, some or all of which may be integrated/removable and/or may provide permanent/semi-permanent/dynamic/cached storage.

The computer program code 425 may comprise computer-executable instructions that implement at least some aspects of operation of the door controller 220 described in the foregoing when loaded into the processor 410. As an example, the computer program code 425 may include a computer program consisting of one or more sequences of one or more instructions. The processor 410 is able to load and execute the computer program by reading the one or more sequences of one or more instructions included therein from the memory 420. The one or more sequences of one or more instructions may be configured to, when executed by the processor 410, cause the apparatus 400 to perform at least some aspects of operation of the door controller 220 described in the foregoing. Hence, the apparatus 400 may comprise at least one processor 410 and at least one memory 420 including the computer program code 425 for one or more programs, the at least one memory 420 and the computer program code 425 configured to, with the at least one processor 410, cause the apparatus 400 to perform at least some aspects of operation of the door controller 220 described in the foregoing.

The computer program code 425 may be provided e.g. a computer program product comprising at least one computer-readable non-transitory medium having the computer program code 425 stored thereon, which computer program code 425, when executed by the processor 410 causes the apparatus 400 to perform at least some aspects of operation of the door controller 220 described in the foregoing. The computer-readable non-transitory medium may comprise a memory device, a record medium or another article of manufacture that tangibly embodies the computer program. As another example, the computer program may be provided as a signal configured to reliably transfer the computer program.

Reference(s) to a processor herein should not be understood to encompass only programmable processors, but also dedicated circuits such as field-programmable gate arrays (FPGA), application specific circuits (ASIC), signal processors, etc.

1. A system for operating an elevator car door, upon an elevator car residing at a landing zone of a landing, the system comprising:
a door coupler comprising one more coupling elements for engaging one or more counter elements of a landing door to couple the landing door to an elevator car door and for disengaging from the one or more counter elements of the landing door to decouple the landing door from the elevator car door;
a locking mechanism comprising
a rotatable lock hook assembly and a lock latch, wherein the lock hook assembly comprises a lock hook portion arranged to selectively engage or disengage the lock latch via rotation of the lock hook assembly to set the locking mechanism, respectively, into a locked state or an unlocked state,
wherein the door coupler is arranged to serve as an actuation assembly for rotating the lock hook assembly;
a safety circuit for indicating a state of the locking mechanism, wherein the safety circuit comprises a switch that is closed in the locked state of the locking mechanism to cause an electric current to flow in the safety circuit and that is open in the unlocked state of the locking mechanism to prevent the electric current from flowing in the safety circuit; and
a door controller arranged to
operate a door driving system, in dependence of movement of the elevator door, to selectively relax the door coupler or to exert a force that causes the door coupler to rotate the lock hook assembly to set the locking mechanism into the locked or unlocked state,
monitor the flow of said electric current in the safety circuit, and
detect compromised operation of the locking mechanism in response to detecting the flow of said electric current upon relaxation of the door coupler when the elevator door is closed,
wherein the door coupler is in a relaxed state when the door driving system does not exert a force to the one or more coupling elements and wherein the system comprises an actuation member coupled to the door coupler and arranged to exert a force that causes the door coupler to rotate the lock hook assembly towards the unlocked position of the locking mechanism upon relaxation of the door coupler, where the force exerted by the actuation member is smaller than the force exerted to the one or more coupling elements of the door coupler by the door driving system.

2. A system according to claim 1, wherein said switch comprises:
a first switch element attached to the lock hook assembly, and
a second switch element disposed in a position where it comes into contact with the first switch element upon rotating the lock hook assembly to set the locking mechanism into the locked state.

3. A system according to claim 2, wherein one of the first and second switch elements comprises one or more plugs and the other one of the first and second switch elements comprises one or more sockets for receiving said one or more plugs to close the switch.

4. A system according to claim 1, wherein the lock hook assembly is rotatable into a first direction to set the locking mechanism into the unlocked state and rotatable into a second direction that is opposite to the first direction to set the locking mechanism into the locked state.

5. A system according to claim 1, wherein the door coupler is arranged to rotate the lock hook assembly to set the locking mechanism into the unlocked state upon coupling the landing door to the elevator car door and to rotate the lock hook to set the locking mechanism into the locked state upon decoupling the landing door from the car door.

6. A system according to claim 1, wherein the door controller is arranged to operate the door driving system to:
exert a first force that causes the door coupler to rotate the lock hook assembly into a first direction to set the locking mechanism into the unlocked state before opening the elevator door upon the elevator car arriving at the landing,
exert a second force that causes the door coupler to rotate the lock hook assembly into a second direction that is opposite to the first direction to set the locking mechanism into the locked state after having opened and closed the elevator door so as to prepare for the elevator car departing from the landing, and
relax the door coupler to cause setting the locking mechanism into the unlocked state in case the elevator car remains at the landing after having opened and closed the elevator door.

7. A system according to claim 1, wherein the door controller is arranged to operate the door driving system to relax the door coupler to cause setting the locking mechanism into the unlocked state after closing the elevator door in case the elevator car remains at the landing.

8. A system according to claim 1, wherein the door controller is arranged to take predefined action in response to detecting compromised operation of the locking mechanism.

9. A system according to claim 1, wherein said elevator door comprises the elevator car door driven by the door driving system.

10. A system according to claim 1, wherein said elevator door comprises a landing door of a landing of an elevator system, wherein the landing door is temporarily couplable to an elevator car door driven by the door driving system via the door coupler connected to the car door when the elevator car resides in a landing zone of a landing such that the landing door moves between the open and closed positions together with the car door.

11. An elevator car for vertical movement within an elevator shaft of an elevator system between a first landing and at least one further landing, the elevator car comprising a car door that is moveable between an open position and a closed position and a system according to claim 1 arranged to operate the car door upon the elevator car residing at a landing zone of the first landing.

12. A system according to claim 2, wherein the lock hook assembly is rotatable into a first direction to set the locking mechanism into the unlocked state and rotatable into a second direction that is opposite to the first direction to set the locking mechanism into the locked state.

13. A system according to claim 3, wherein the lock hook assembly is rotatable into a first direction to set the locking mechanism into the unlocked state and rotatable into a second direction that is opposite to the first direction to set the locking mechanism into the locked state.

14. A system according to claim 2, wherein the door coupler is arranged to rotate the lock hook assembly to set the locking mechanism into the unlocked state upon coupling the landing door to the elevator car door and to rotate the lock hook to set the locking mechanism into the locked state upon decoupling the landing door from the car door.

15. A system according to claim 3, wherein the door coupler is arranged to rotate the lock hook assembly to set the locking mechanism into the unlocked state upon coupling the landing door to the elevator car door and to rotate the lock hook to set the locking mechanism into the locked state upon decoupling the landing door from the car door.

16. A system according to claim 4, wherein the door coupler is arranged to rotate the lock hook assembly to set the locking mechanism into the unlocked state upon coupling the landing door to the elevator car door and to rotate the lock hook to set the locking mechanism into the locked state upon decoupling the landing door from the car door.

17. A system according to claim 2, wherein the door controller is arranged to operate the door driving system to:
exert a first force that causes the door coupler to rotate the lock hook assembly into a first direction to set the locking mechanism into the unlocked state before opening the elevator door upon the elevator car arriving at the landing,
exert a second force that causes the door coupler to rotate the lock hook assembly into a second direction that is opposite to the first direction to set the locking mechanism into the locked state after having opened and closed the elevator door so as to prepare for the elevator car departing from the landing, and
relax the door coupler to cause setting the locking mechanism into the unlocked state in case the elevator car remains at the landing after having opened and closed the elevator door.

18. A system according to claim 3, wherein the door controller is arranged to operate the door driving system to:
exert a first force that causes the door coupler to rotate the lock hook assembly into a first direction to set the locking mechanism into the unlocked state before opening the elevator door upon the elevator car arriving at the landing,
exert a second force that causes the door coupler to rotate the lock hook assembly into a second direction that is opposite to the first direction to set the locking mechanism into the locked state after having opened and closed the elevator door so as to prepare for the elevator car departing from the landing, and
relax the door coupler to cause setting the locking mechanism into the unlocked state in case the elevator car remains at the landing after having opened and closed the elevator door.

19. A system according to claim 4, wherein the door controller is arranged to operate the door driving system to:
exert a first force that causes the door coupler to rotate the lock hook assembly into a first direction to set the locking mechanism into the unlocked state before opening the elevator door upon the elevator car arriving at the landing,
exert a second force that causes the door coupler to rotate the lock hook assembly into a second direction that is opposite to the first direction to set the locking mechanism into the locked state after having opened and closed the elevator door so as to prepare for the elevator car departing from the landing, and
relax the door coupler to cause setting the locking mechanism into the unlocked state in case the elevator car remains at the landing after having opened and closed the elevator door.

20. A system according to claim 5, wherein the door controller is arranged to operate the door driving system to:
exert a first force that causes the door coupler to rotate the lock hook assembly into a first direction to set the locking mechanism into the unlocked state before opening the elevator door upon the elevator car arriving at the landing,
exert a second force that causes the door coupler to rotate the lock hook assembly into a second direction that is opposite to the first direction to set the locking mechanism into the locked state after having opened and closed the elevator door so as to prepare for the elevator car departing from the landing, and
relax the door coupler to cause setting the locking mechanism into the unlocked state in case the elevator car remains at the landing after having opened and closed the elevator door.
